(19) United States
(12) Patent Application Publication
(10) Pub. No.: US 2012/0079517 A1
(43) Pub. Date: Mar. 29, 2012

(54) VIEWERSHIP-BASED SERVICES

(76) Inventors: Mark D. Yarvis, Portland, OR (US); Kimra McPherson, San Francisco, CA (US)

(21) Appl. No.: 12/890,401

(22) Filed: Sep. 24, 2010

(51) Int. Cl. H04H 60/32

(52) U.S. Cl. 725/14

(57) ABSTRACT

A method, system, and computer program product containing instructions to provide viewership-based services. In response to a request to participate in a service transaction by a user of a service, a viewership status of the user is determined with respect to an episode of a series of episodes. The service transaction is modified to accommodate the viewership status of the user. Modifying the service transaction may include providing content related to a first episode in the series if the viewership status indicates the user has viewed the first episode and withholding content related to a second episode in the series if the viewership status indicates that the user has not viewed the second episode. Modifying the service transaction may include writing a post by the user to a collection of posts that is accessible only by users having a given viewership status.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

The present disclosure relates generally to providing services for viewers of video content.

### BACKGROUND

The television has become a ubiquitous part of today's society. People everywhere watch television as part of their daily lives, and many become fans of television series and follow each episode closely. With the ability to record video content for later viewing or to use the Internet to download or stream video content, viewers are no longer tied to the schedule for broadcast television, but can view episodes of serial shows on demand. Typically, with most television shows, episodes are available to be downloaded or streamed via the Internet only after the episode has been aired as a broadcast.

Internet-based information sharing and social interaction can significantly boost the enjoyment of serial video content (whether in the form of broadcast television or downloadable/streamable content). Online discussion groups and social networking sites such as Facebook and Twitter may add considerably to the viewer's enjoyment of serial content.

### BRIEF DESCRIPTION OF THE DRAWINGS

FIG. 1 is a block diagram depicting a suitable data processing environment in which certain aspects of an example embodiment of viewership-based services may be implemented.

FIG. 2 is a diagram showing communication flows in a viewership-based discussion forum in accordance with one embodiment of the invention.

FIG. 3 is a diagram of a timeline for communication with a prior art discussion forum.

FIG. 4 is a diagram of a timeline for communication in a viewership-based discussion forum in accordance with one embodiment of the invention.

FIG. 5 is a diagram of a system for implementing a viewership-based discussion forum service in accordance with one embodiment of the invention.

FIG. 6 is a flowchart for operation of a viewership-based discussion forum service.

FIG. 7 is an example of a user interface for a viewership-based instant messaging service.

FIG. 8 is a diagram of a system for implementing a viewership-based instant messaging service in accordance with one embodiment of the invention.

### DETAILED DESCRIPTION

While the social interaction available via the Internet increases the enjoyment of viewers, it also increases the opportunity for spoilers (information about plot developments that would be surprising to a viewer watching an episode for the first time). For example, the last episode of the TV show Lost is about to air at 8 p.m. on the West coast. Frank is eager to watch, but he has been avoiding participation in online discussion at fan sites—and staying away from his Facebook and Twitter pages—since 5 p.m., because he knows the show started airing at that time on the East coast. While East coast viewers can chat online while viewing in real time, West coast viewers have exposure to possible spoilers starting 3 hours before airtime, through the end of the show.

As another example of the possibility of spoilers, John has never seen the TV show True Blood, but he's heard good things. He has rented the first DVD from Netflix. He'd like to participate in online discussion with other viewers who are at the same point in the series as he is. Unfortunately, he cannot use the typical discussion boards on fan websites, because there is too much risk that he will be exposed to spoilers from people who have seen episodes he has not yet seen.

As another example of the possibility of spoilers, Randy is chatting online with his college buddy Tim. Randy immediately asks Tim if he can believe that UCLA beat SC in last night's game. Unfortunately, Tim was going watch the game on his TiVo this evening.

These examples suggest the need for online services that are sensitive to the viewership status of the users. Viewership-based services may be tailored to the set of content that a user has viewed. This capability can be enabled by sending a list of relevant content identifiers and episode information along with a given service transaction request. This content identifier and episode information represents which content a user has viewed, and may take the form of an highest episode number that the user has viewed, a list of episodes in a series of episodes that the user has viewed, a listing of times of broadcasts that the user has viewed, or any other indication of how much of a particular series of episodes of content that the user has seen.

Described herein are a method, system, and computer program product for modifying a service transaction to accommodate the viewership status of a user. In one embodiment, the method includes, in response to a request to participate in a service transaction by a user of a service, determining a viewership status of the user with respect to an episode of a series of episodes and modifying the service transaction to accommodate the viewership status of the user. In one embodiment, modifying the service transaction comprises providing content related to a first episode in the series if the viewership status indicates the user has viewed the first episode and withholding content related to a second episode of the series of episodes if the viewership status indicates that the user has not viewed the second episode. In another embodiment, modifying the service transaction comprises writing a post by the user to a collection of posts, wherein the collection of posts is accessible by other users who have viewed a highest episode that the user has viewed. The method may further include writing the post to a second collection of posts, wherein the second collection of posts is accessible by other users that have not yet viewed the highest episode; and labeling the post to indicate that the post may include spoiler information.

In another embodiment, modifying the service transaction comprises alerting another user participating in the service transaction that the viewership status indicates that the user has not viewed the episode. In yet another embodiment, modifying the service transaction comprises limiting other users participating in the service transaction to users having a respective viewership status that is the same as the viewership status of the user. In another embodiment, modifying the service transaction comprises alerting the user that another user participating in the service transaction has not viewed the episode.

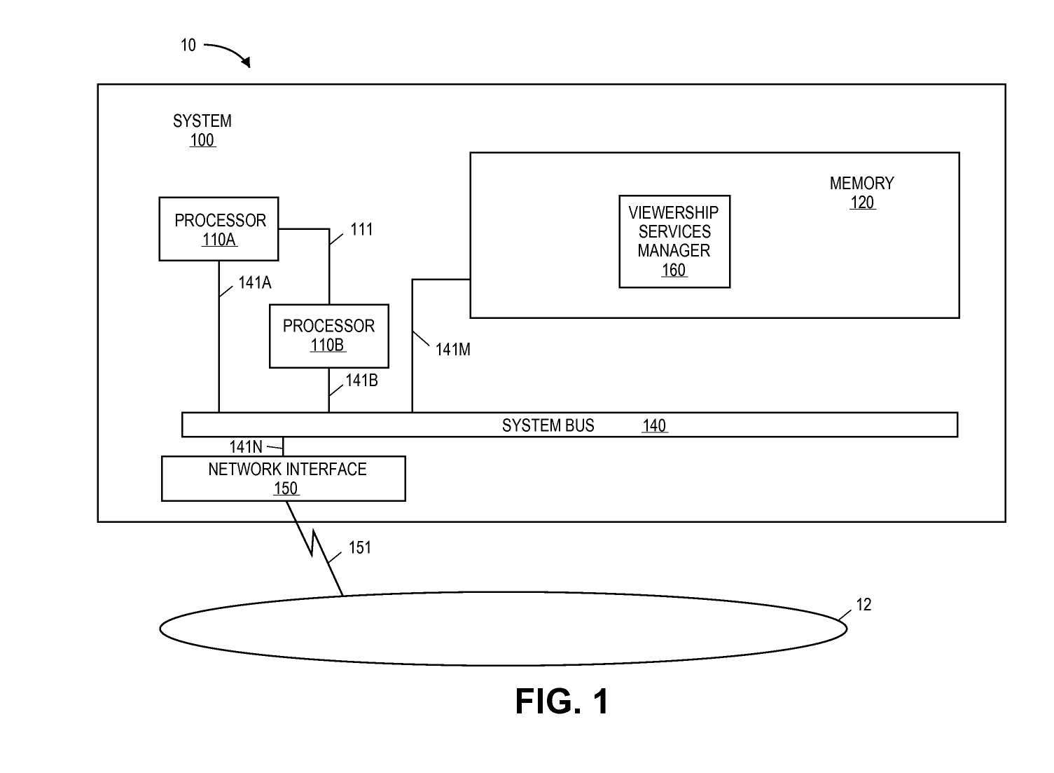

FIG. 1 is a block diagram depicting a suitable data processing environment 10 in which certain aspects of an example embodiment of viewership-based services may be implemented. Data processing environment 10 includes a processing system 100 that includes one or more processors or central processing units (CPUs), shown here as processors 110A and 110B. One of skill in the art will recognize that, while two processors are shown, a single processor or any number of multiple processors may provide processor functionality to processing system 100. Each of processors 110A and 110B may be a single-core or a multi-core processor. Processors 110A and 110B are shown as communicatively coupled to various other components including a memory 120 via one or more system buses 140 or other communication pathways or mediums. Processors 110A and 110B are also shown as connected via a point-to-point processor interconnection 111, such as a HyperTransport link or an Intel QuickPath Interconnect (QPI). Viewership services manager 160 may be implemented as instructions executed by processor 110A and/or processor 110B within memory 120.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, mobile Internet devices (MIDs), and other devices for processing or transmitting information.

Processing system 100 may be controlled, at least in part, by input from conventional input devices, such as keyboards, mice, etc., and/or by directives received from another machine, biometric feedback, or other input sources or signals. Processing system 100 may utilize one or more connections to one or more remote data processing systems (not shown) in data processing environment 10, such through a network interface controller (NIC) such as network interface 150, a modem, or other communication ports or couplings. Processing system 100 may be interconnected to such remote data processing systems by way of a physical and/or logical network 12, such as a local area network (LAN), a wide area network (WAN), an intranet, the Internet, etc. Communications involving network 12 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

Within processing system 100, processors 110A and 110B may be communicatively coupled to one or more volatile or non-volatile data storage devices, such as memory 120. Memory 120 may include random access memory (RAM), read-only memory (ROM), mass storage devices such as integrated drive electronics (IDE) hard drives, and/or other devices or media, such as floppy disks, optical storage, tapes, flash memory, memory sticks, digital video disks, biological storage, etc. For purposes of this disclosure, the term “ROM” may be used in general to refer to non-volatile memory devices such as erasable programmable ROM (EPROM), electrically erasable programmable ROM (EEPROM), flash ROM, flash memory, etc. Processors 110A and 110B may also be communicatively coupled to additional components, such as video controllers, small computer system interface (SCSI) controllers, network controllers, universal serial bus (USB) controllers, input devices such as a keyboard and mouse, etc. Processing system 100 may also include one or more bridges or hubs, such as a memory controller hub, an input/output (I/O) controller hub, a PCI root bridge, etc., for communicatively coupling various system components. As used herein, the term “bus” may be used to refer to shared communication pathways, as well as point-to-point pathways.

Some components, such as a NIC for example, may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

System 100 includes processors 110A and 110B and memory 120. Memory 120 may be virtually separated by an operating system or other software into process address spaces. Processors 110A and 110B are connected to memory 120 via system bus 140 and interconnections 141a, 141b, and 141m. System bus 140 also provides access to network interface 150 via interconnection 141n.

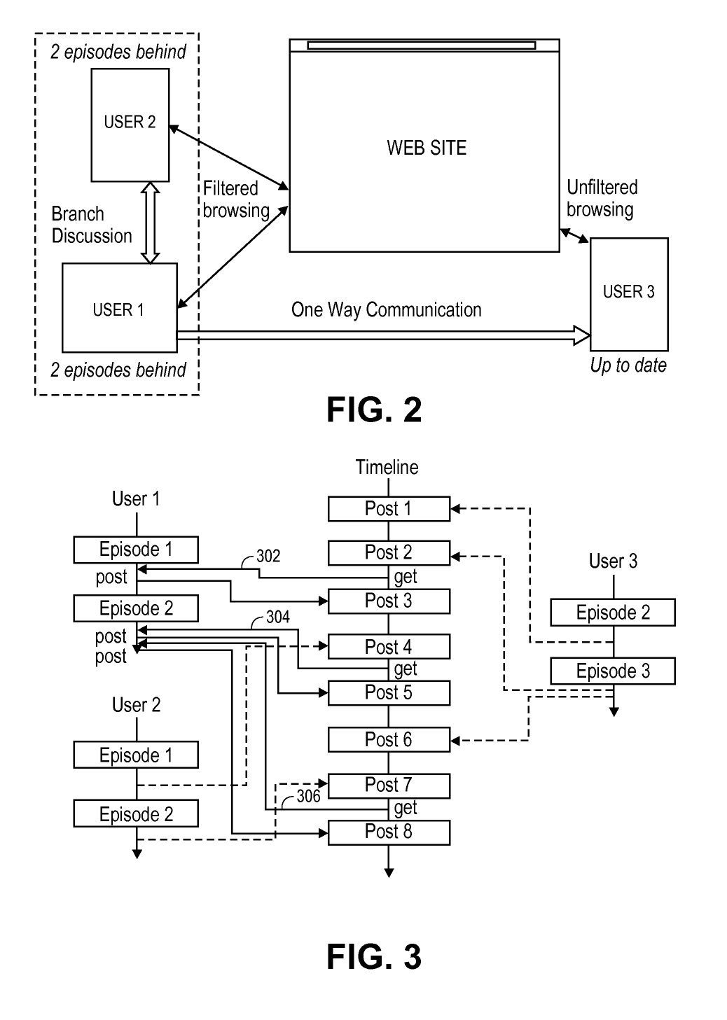

FIG. 2 is a diagram showing communication flows in a viewership-based discussion forum in accordance with one embodiment of the invention. In FIG. 2, three users (User 1, User 2, and User 3) are participating in an online discussion forum, perhaps as part of a TV series' fan website. Users such as User 3 who have seen the latest episode in the series (in this example, episode 4) can expect to see all content on the website in an unfiltered form. Users who are, for example, two episodes behind (such as Users 1 and 2, who have seen episodes 1 and 2 but not episodes 3 and 4) see all content generated by users who (at the time of their post) had not seen the last two episodes. Thus, users who are two episodes behind can have an online discussion about the episode they most recently viewed without inadvertently receiving spoilers from users who have seen more recent content. This online discussion is referred to as a “branch discussion,” and it is limited to postings by users having the same viewership status, such as User 1 and User 2. Each request to “get” a posting from the discussion forum or to “post” a message to the discussion forum is a request for a service transaction. The service transaction is modified to accommodate the viewership status of the user; for example, the postings provided in response to a request to “get” a posting include only those postings that were made by users with a viewership status that was (at the time of the post) the same as (or earlier than) the requesting user's current viewership status. A request to post a message to a discussion forum will be provided only to those discussion forums with a viewership status that is the same as (or later than) the viewership status of the user posting the message. Similarly, in response to a request to browse web pages from the series' fan website, the service transaction is modified to provide only those web pages with content related to episodes that the user has seen as provided in the user's current viewership status information; other web pages are withheld if related to an episode that the user has not yet viewed.

Users who have seen more recent episodes can also see the content by users who are two episodes behind, resulting in one-way communication. For example, User 3 can see postings by Users 1 and 2, but Users 1 and 2 cannot see postings from User 3 about episodes 3 and 4. Users 1 and 2 can, however, only see postings made by User 3 prior to the time that User 3 had viewed episodes subsequent to episodes 1 and 2. If users who have seen recent episodes wanted to respond to postings from users who were not “caught up” on the series, they can do so through an explicit action, but they would be reminded that the user to whom they were replying was two episodes behind, suggesting that they should moderate their comments to avoid posting spoilers. This feature is enabled because each request to read or post information from or to the website includes the viewership status of episodes in the series being discussed.

FIG. 3 is a diagram of a timeline for communication with a prior art discussion forum. User 3 is the farthest along in viewing the series, having viewed episodes 1, 2, and 3. User 3 makes the first posting after viewing episode 2 and the second posting after seeing episode 3. User 1 views episode 1, and then gets postings from the website, as shown by arrow 302. Because post 1 and post 2 were posted by user 3 after seeing episodes 2 and 3, respectively, each of these posts potentially contains a spoiler. User 1 then submits post 3, and then user 2 views episode 1 and submits post 4. When user 2 submits post 4, he may get/read the other 3 posts, as shown by arrow 304, which may present another spoiler opportunity. Because no control is placed on whether a user can view a particular post, many opportunities for spoilers arise. Posts 5 and 6 both provide spoiler opportunities for user 2, and posts 7 and 8 provide spoiler opportunities for other users (not shown) that have not yet viewed episodes 1 and 2. The get/read transaction shown by arrow 306 represents a spoiler opportunity for user 1, having still not viewed episode 3.

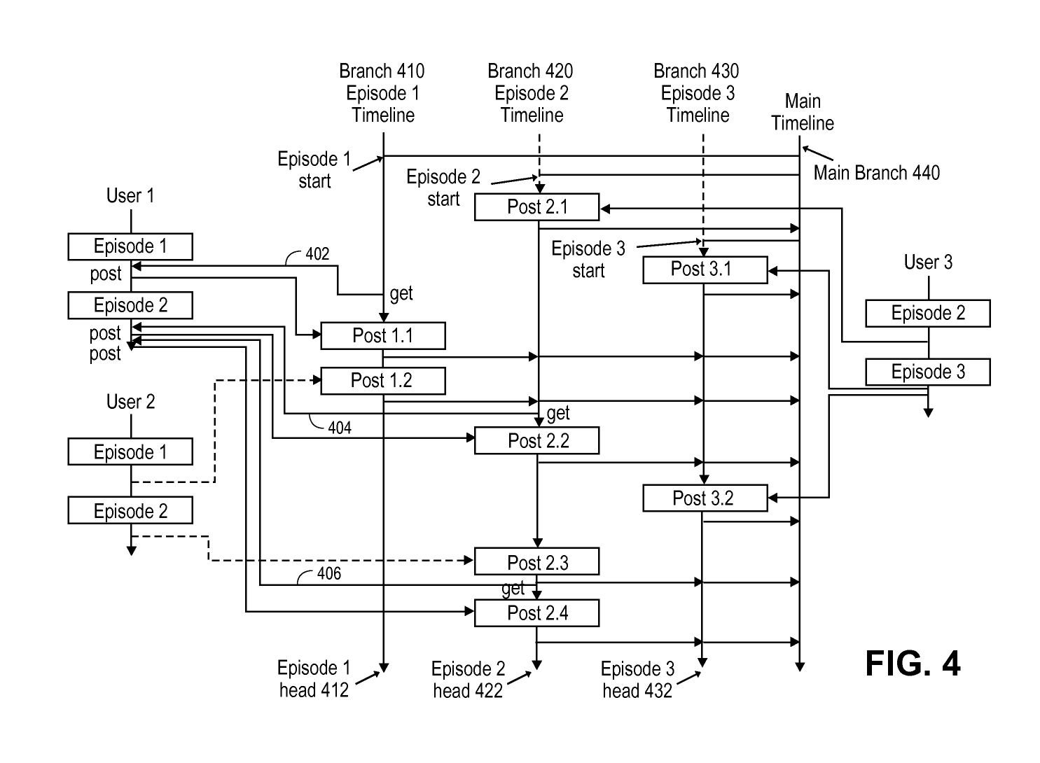

FIG. 4 is a diagram of a timeline for communication in a viewership-based discussion forum in accordance with one embodiment of the invention. Related submissions/postings and reads are grouped in “branches,” which may be merged at various points. In this case, each branch represents a given episode in the series; branch 410 corresponds to Episode 1; branch 420 corresponds to Episode 2, branch 430 corresponds to Episode 3, and the main branch 440 corresponds to an unfiltered discussion. Users who have viewed up to Episode N perform update and read requests on branch N. In one embodiment, updates to branch N are automatically applied to all subsequently-numbered branches and to main branch 440, but not to previously-numbered branches. New branches are created from the main branch 440 which contains all updates to that point. Updates to a branch are made at the head of the branch, such as episode 1 head 412, episode 2 head 422, or episode 3 head 432.

From our previous example, the first post by User 3 is labeled Post 2.1. Post 2.1 is placed on branch 420 for Episode 2 because that is the most up-to-date episode that User 3 has viewed at the time of his post. User 3 then views Episode 3, and user 3's second post is labeled Post 3.1 and is applied to branch 430 for Episode 3. When User 1 performs his first read/get request at arrow 402 after viewing only Episode 1, User 1 does not see Post 2.1 or Post 3.1, as his operation is performed on the Episode 1 branch 410. User 1's first post is applied as Post 1.1 on the branch 410 for Episode 1. User 3 is able to see this post because he has seen the first three episodes already. User 2 is able to see Post 1.1 after he sees Episode 1. Similarly, User 1 will be able to see Post 2.1 after he has seen Episode 2 at the point in time represented by arrow 404. User 1 will be able to see Posts 2.2 and 2.3 when he issues a get/read request at the point in time represented by arrow 406. In this manner, users are insulated from updates made by other users that have viewed content that they themselves have not seen.

Postings appear on the main timeline in the following order: 2.1, 3.1, 1.1, 1.2, 2.2, 3.2, 2.3, 2.4. At the current point in time (the bottom of the timeline in FIG. 4), User 3, having viewed all 3 episodes, can see all eight of these postings, whereas Users 1 and 2, having viewed only 2 episodes, can see posts 2.1, 1.1, 1.2, 2.2, 2.3, and 2.4 on the Episode 2 branch 420.

Note that while the above discussion suggests that a user always interacts with the branch associated with his current episode, in one embodiment, users may submit posts on branches associated with episodes earlier than the user's current episode. This capability allows users to communicate with users who are not as far along in the series, perhaps to respond to a post by such a user. In this embodiment, the user interface may require the posting to be an explicit action requiring an extra confirmation step by the user and providing adequate warning that this posting is at risk of generating spoilers. In some embodiments, such posts may also be automatically labeled as potentially containing spoilers.

The classification scheme described above for postings to a discussion forum can also be used, for example, to classify the content of web pages available for viewing at a fan website. Only those web pages that do not contain “spoiler” content could be returned in response to a request to read information from the fan website. Thus the viewership status of the user can be taken into account when providing web page content to users.

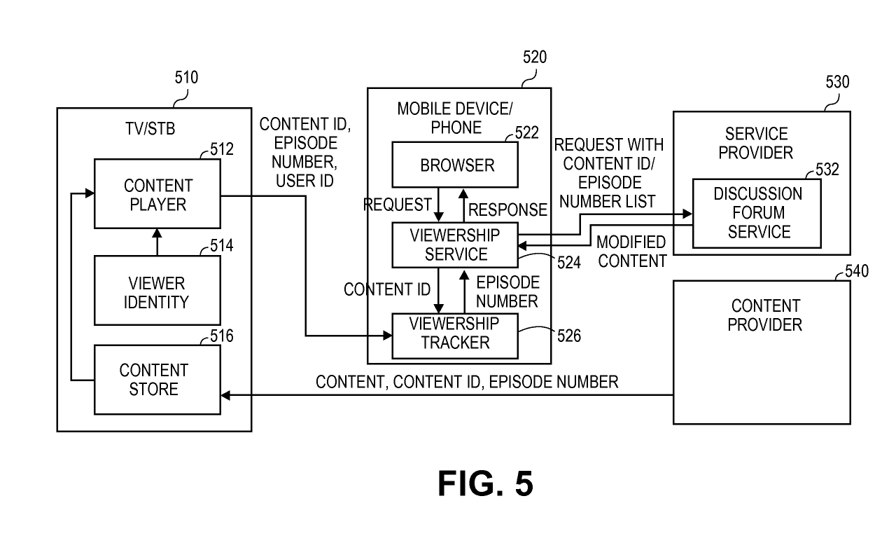

FIG. 5 is a diagram of a system for implementing a viewership-based discussion forum service in accordance with one embodiment of the invention. When content is provided for viewing by content provider 540 to a television/set top box 510, additional information uniquely identifying the content is also provided. In the example shown, a content ID identifying the series and an episode number within the series are also provided along with the content. This information may be obtained from a content guide service such as Tribune. The content and identifying information is stored in a content store 516 in the TV/set top box 510. Content is played by a content player 512, which also obtains a viewer identity of a viewer watching the episode. The user's identity may be obtained using a variety of different technologies, including sensing by audio voiceprint, fingerprint or face recognition, or by explicit selection of a user profile. Multiple users may also be identified and associated with the viewing of an episode.

Using a mobile device/phone 520, the user interacts with a discussion forum service 532 for a given television series provided by service provider 530. This interaction may take place while watching an episode of the series or afterwards. The user submits a request for a service transaction with discussion forum service 532 using browser 522, and viewership service 524 provides a response to the request. Before contacting discussion forum service 532, viewership service 524 obtains a content ID for the discussion forum service 532 from the service request provided by browser 522. Viewership service 524 provides the content ID from the request to viewership tracker 526, and obtains in return an episode number representing the viewership status of the user for that series. In each request to read/get or post a message to discussion forum service 532, viewership service 524 includes viewership status in the form of a list of relevant content IDs and episode numbers representing a most recent episode in each series that has been viewed by the user. The methodology described with reference to FIG. 4 to filter the postings that can be viewed by the user is used to formulate a response to the request for a service transaction.

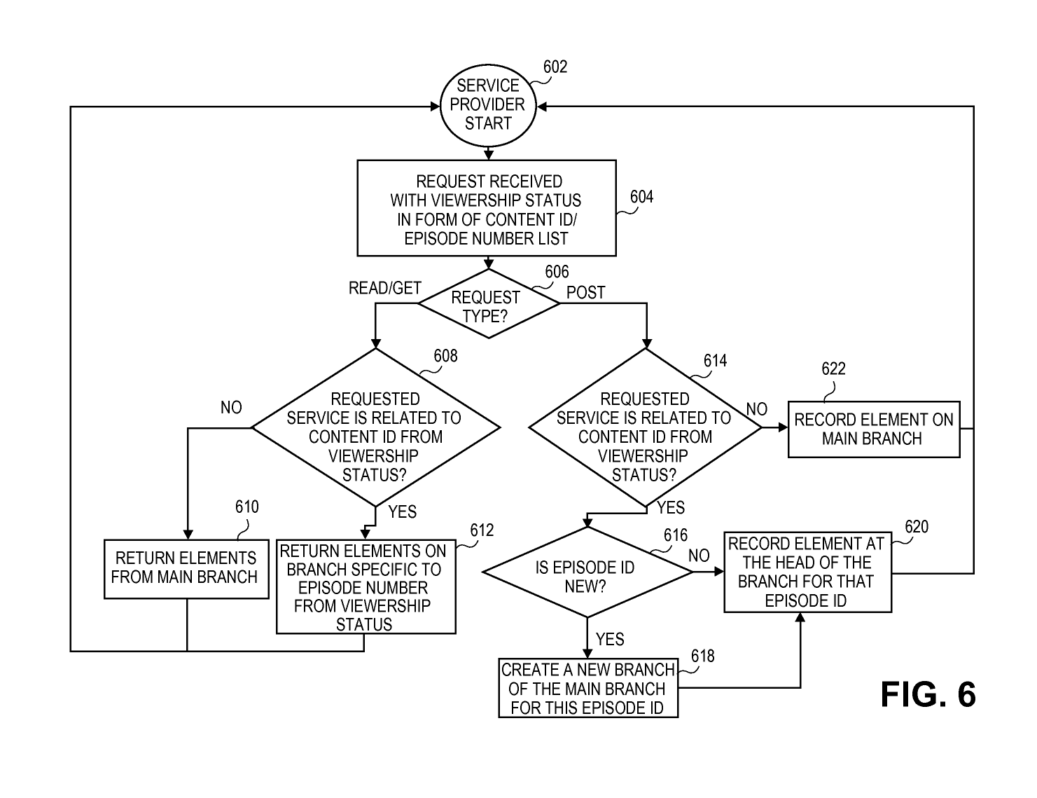

FIG. 6 is a flowchart for operation of a viewership-based discussion forum service. The steps of the flowchart will be described as being performed by the components of the system of FIG. 5. At “Service Provider Start” step 602, a service provider such as service provider 530 of FIG. 5 begins operations to provide a discussion forum service to users. At “Request Received with Viewership Status in Form of Content ID/Episode Number List” step 604, a request is received from a user to participate in a service transaction. In the embodiment described, the request includes the user's viewership status in the form of a content ID to identify the series and an episode number to identify the episode within the series. As described above, other ways to uniquely identify the user's viewership status are within the scope of the invention.

Upon receiving the request to participate in a discussion forum service transaction, control proceeds to “Request Type” decision point 606. If the request is to read or get information from the discussion forum, control proceeds to “Requested Service is Related to Content ID from Viewership Status?” decision point 608. This decision point determines whether the discussion forum from which the postings are to be read is related to any of the content IDs in the user's viewership status. If the request is not related to any of the content IDs provided in the user's viewership status, possible scenarios are that the request contains no content IDs or that none of the content IDs in the viewership status match the content ID of the discussion forum. In such scenarios, no potential for a spoiler situation exists or the user does not desire viewership-based service, and control proceeds to “Return Elements from Main Branch” step 610. Postings would then be returned from a main branch of postings, such as main branch 440 of FIG. 4, which would include all postings for all episodes. Control then returns to “Service Provider Start” step 602 to await another user request.

At “Requested Service is Related to Content ID from Viewership Status?” decision point 608, if the request is related to one of the content IDs provided in the user's viewership status, the potential for a spoiler situation exists and viewership-based service is desired. Control then proceeds to “Return Elements on Branch Specific to Episode Number from Viewership Status” step 612. Only those elements in the branch specific to the highest episode number that the user has viewed will be returned. Control then returns to “Service Provider Start” step 602 to await another user request.

At “Request Type” decision point 606, if the request is to post information to the discussion forum, control proceeds to “Requested Service is Related to Content ID from Viewership Status?” decision point 614. This decision point determines whether the requested service to post information is related to any of the content IDs in the user's viewership status. If the particular forum to which the user is requesting to post is related to any of the content IDs in the user's viewership status, then control proceeds to “Is Episode ID new?” decision point 616. If this posting is the first posting for this episode, then the episode ID is new and control proceeds to “Create a New Branch of the Main Branch for this Episode ID” step 618. A new branch similar to the branches of FIG. 4 (namely branches 410, 420, and 430 for episodes 1, 2, and 3, respectively) would be created for the new episode. The new branch would contain the postings from the main branch for episodes that occurred prior to the episode for which the branch is being created. For example, when branch 410 is created in FIG. 4 from main branch 440, postings 2.1 and 3.1 for episodes 2 and 3 are not included in branch 410 even though they were posted at an earlier point in time. Only those postings for episodes that occurred prior to the episode for which the branch is being created (episode 1 in the case of branch 410) would be included to prevent a spoiler situation.

At “Is Episode ID new?” decision point 616, if this posting is not the first posting for this episode, then control proceeds to “Record Element at the Head of the Branch for the Episode ID” step 620. The new posting will be recorded at the head of the branch, such as at episode 2 head 422 of FIG. 4, for a posting by a user whose viewership status indicates that episode 2 is the most recent episode viewed. Control then returns to “Service Provider Start” step 602 to await another user request.

At “Requested Service is Related to Content ID from Viewership Status?” decision point 614, this decision point determines whether the requested service to post information is related to any of the content IDs in the user's viewership status. If the particular forum to which the user is requesting to post is not related to any of the content IDs in the user's viewership status, then control proceeds to “Record Element on Main Branch” step 622. The posting is recorded on the main branch and will be provided whenever postings for all episodes are requested and the user has viewed all episodes.

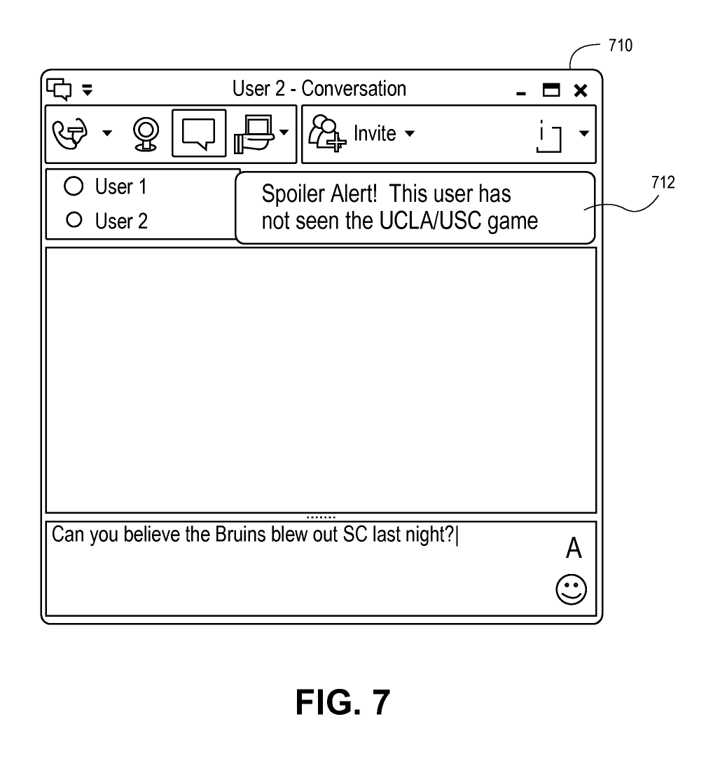

FIG. 7 is an example of a user interface for a viewership-based instant messaging service. Whenever a user requests to engage in an instant messaging service transaction with another user, a user interface similar to user interface 710 is presented. In accordance with an embodiment of the present invention, when the instant messaging service transaction is initiated, the viewership status of both users can be determined. A spoiler alert 712 can be provided to a user whose viewership status differs from the other participant in the instant messaging service transaction.

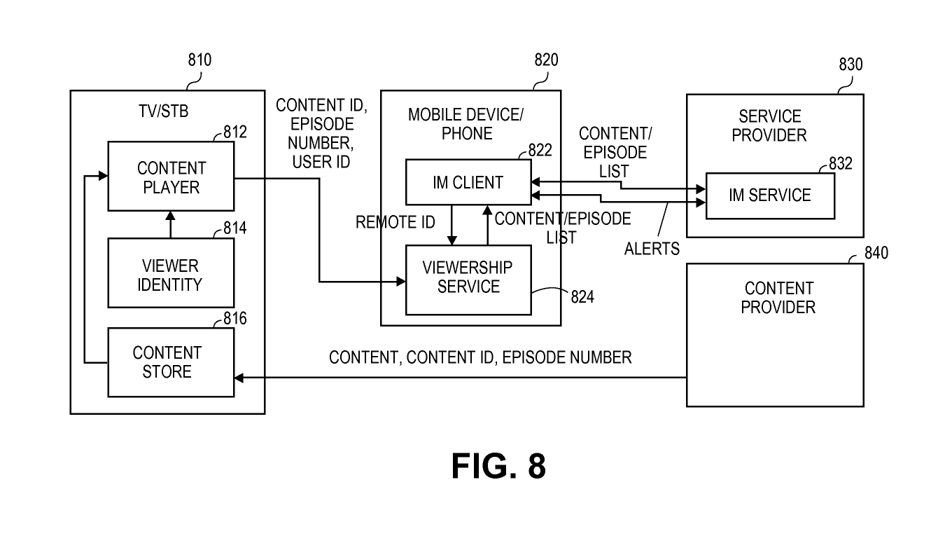

FIG. 8 is a diagram of a system for implementing a viewership-based instant messaging service in accordance with one embodiment of the invention. When content is provided for viewing by content provider 840 to a television/set top box 810, additional information uniquely identifying the content is also provided. In the example shown, a content ID and episode number are also provided along with the content. This information may be obtained from a content guide service such as Tribune. The content and identifying information is stored in a content store 816 in the TV/set top box 810. Content is played by a content player 812, which also obtains a viewer identity of a viewer watching the episode. The user's identity may be obtained using a variety of different technologies, including sensing by audio voiceprint, fingerprint or face recognition, or by explicit selection of a user profile. Multiple users may also be identified and associated with the viewing of an episode.

Using a mobile device/phone 820, the user interacts with instant messaging service 832 provided by service provider 830. This interaction may take place while watching the episode or afterwards. Before contacting instant messaging service 832, the user's instant messaging (IM) client 822 provides a remote ID for the other user in the instant messaging service transaction to a viewership service 824. In each request to send or receive a message via instant messaging service 832, IM client 822 includes viewership status for each user in the form of a list of relevant content IDs and episode numbers representing a most recent episode in each series that has been viewed by the users participating in the instant messaging transaction. Instant messaging service 832 then can alert IM client 822 to send a message to the user that a potential spoiler situation exists.

While the example of FIG. 8 describes two users interacting in an instant messaging transaction, more than two users may be involved in a chat room discussion and the same filtering concepts can apply.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code may be applied to input data to perform the functions described herein and generate output information. Embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash programmable memories (FLASH), electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for providing viewership services. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A computer-implemented method performed by a viewership services manager executed by a processor, the method comprising:
in response to a request to participate in a service transaction by a user of a service, determining a viewership status of the user with respect to each episode of a series of episodes; and
modifying the service transaction to accommodate the viewership status of the user.

2. The method of claim 1 wherein
modifying the service transaction comprises
providing content related to a first episode in the series if the viewership status indicates the user has viewed the first episode; and
withholding content related to a second episode in the series if the viewership status indicates that the user has not viewed the second episode.

3. The method of claim 1 wherein
modifying the service transaction comprises
writing a post by the user to a collection of posts, wherein the collection of posts is accessible by other users who have viewed a highest episode that the user has viewed.

4. The method of claim 3 further comprising:
writing the post to a second collection of posts, wherein the second collection of posts is accessible by users that have not yet viewed the highest episode; and
labeling the post to indicate that the post may include spoiler information.

5. The method of claim 1 wherein
modifying the service transaction comprises alerting another user participating in the service transaction that the user has not viewed a given episode.

6. The method of claim 1 wherein
modifying the service transaction comprises limiting other users participating in the service transaction to users having a respective viewership status that is the same as the viewership status of the user.

7. The method of claim 1 wherein
modifying the service transaction comprises alerting the user that another user participating in the service transaction has not viewed a given episode.

8. The method of claim 1 wherein
modifying the service transaction comprises allowing other users to participate in the service transaction if the other users have a different viewership status than the user; and
alerting the other users that the user has not viewed a given episode.

9. A system comprising:
at least one processor; and
a memory comprising instructions configured to perform operations comprising:
in response to a request to participate in a service transaction by a user of a service, determining a viewership status of the user with respect to each episode of a series of episodes; and
modifying the service transaction to accommodate the viewership status of the user.

10. The system of claim 9 wherein
modifying the service transaction comprises
providing content related to a first episode in the series if the viewership status indicates the user has viewed the first episode; and
withholding content related to a second episode in the series if the viewership status indicates that the user has not viewed the second episode.

11. The system of claim 9 wherein
modifying the service transaction comprises
writing a post by the user to a collection of posts, wherein the collection of posts is accessible by other users who have viewed a highest episode that the user has viewed.

12. The system of claim 11 wherein the instructions further comprise instructions to perform the following operations:
writing the post to a second collection of posts, wherein the second collection of posts is accessible by users that have not yet viewed the highest episode; and
labeling the post to indicate that the post may include spoiler information.

13. The system of claim 9 wherein
modifying the service transaction comprises alerting another user participating in the service transaction that the user has not viewed a given episode.

14. The system of claim 9 wherein
modifying the service transaction comprises limiting other users participating in the service transaction to users having a respective viewership status that is the same as the viewership status of the user.

15. The system of claim 9 wherein
modifying the service transaction comprises alerting the user that another user participating in the service transaction has not viewed a given episode.

16. The system of claim 9 wherein
modifying the service transaction comprises allowing other users to participate in the service transaction if the other users have a different viewership status than the user; and
alerting the other users that the user has not viewed a given episode.

17. A computer program product comprising:
a computer-readable storage medium; and
instructions in the computer-readable storage medium, wherein the instructions, when executed in a processing system, cause the processing system to perform operations comprising:
in response to a request to participate in a service transaction by a user of a service, determining a viewership status of the user with respect to each episode of a series of episodes; and
modifying the service transaction to accommodate the viewership status of the user.

18. The computer program product of claim 17 wherein
modifying the service transaction comprises
providing content related to a first episode in the series if the viewership status indicates the user has viewed the first episode; and
withholding content related to a second episode in the series if the viewership status indicates that the user has not viewed the second episode.

19. The computer program product of claim 17 wherein
modifying the service transaction comprises
writing a post by the user to a collection of posts, wherein the collection of posts is accessible by other users who have viewed a highest episode that the user has viewed.

20. The computer program product of claim 19 wherein the instructions further comprise instructions to perform the following operations:
writing the post to a second collection of posts, wherein the second collection of posts is accessible by users that have not yet viewed the highest episode; and
labeling the post to indicate that the post may include spoiler information.

21. The computer program product of claim 17 wherein
modifying the service transaction comprises alerting another user participating in the service transaction that the user has not viewed a given episode.

22. The computer program product of claim 17 wherein
modifying the service transaction comprises limiting other users participating in the service transaction to users having a respective viewership status that is the same as the viewership status of the user.

23. The computer program product of claim 17 wherein
modifying the service transaction comprises alerting the user that another user participating in the service transaction has not viewed a given episode.

24. The computer program product of claim 17 wherein
modifying the service transaction comprises allowing other users to participate in the service transaction if the other users have a different viewership status than the user; and
alerting the other users that the user has not viewed a given episode.
